(19) United States
(12) Patent Application Publication
(10) Pub. No.: US 2019/0237239 A1
(43) Pub. Date: Aug. 1, 2019

(54) COIL COMPONENT

(71) Applicant: TDK CORPORATION, Tokyo (JP)

(72) Inventors: Hajime KATO, Tokyo (JP); Satoru OKAMOTO, Tokyo (JP); Masahiro KATO, Yurihonjo-city (JP); Makoto YOSHINO, Tokyo (JP); Kazuya TOBITA, Tokyo (JP); Yuto SHIGA, Tokyo (JP); Youichi KAZUTA, Tokyo (JP); Noriaki HAMACHI, Tokyo (JP)

(73) Assignee: TDK CORPORATION, Tokyo (JP)

(21) Appl. No.: 16/249,132

(22) Filed: Jan. 16, 2019

(30) Foreign Application Priority Data
Jan. 29, 2018 (JP) 2018-012830

(51) Int. Cl. H01F 27/28; H01F 27/29

(52) U.S. Cl. CPC H01F 27/2804; H01F 2027/2809; H01F 27/29

(57) ABSTRACT

A laminated coil component 1 includes an element body 2, a coil 8 disposed in the element body 2, and a first external electrode 4 and a second external electrode 5, and at least a part of the coil 8 is disposed in a first region A1 and a second region A2 when seen in a facing direction of the pair of side surfaces 2e and 2f, and the coil 8 is not disposed in a third region A3 and a fourth region A4 when seen in the facing direction of the pair of side surfaces 2e and 2f.

### TECHNICAL FIELD

An aspect of the present invention relates to a coil component.

### BACKGROUND

As a conventional coil component, for example, one described in Patent Document 1 (Japanese Unexamined Patent Publication No. 2017-5087) is known. The coil component disclosed in Patent Document 1 includes an element body having a pair of end surfaces facing each other, a pair of main surfaces facing each other, a pair of side surfaces facing each other, a coil disposed in the element body, and a pair of external electrodes disposed on the sides of the pair of end surfaces of the element body. In the coil component described in Patent Document 1, a coil axis of the coil extends in a direction opposite to the pair of side surfaces.

### SUMMARY

When the coil component is mounted on a circuit board or the like and bending occurs in the element body, cracks may be generated in the element body. In the coil component, when the bending occurs, stress tends to concentrate on an edge of the external electrode disposed on a mounting surface (one main surface). Therefore, the cracks in the element body may occur toward the end surface starting from the edge of the external electrode. In a configuration in which the coil is electrically connected to the external electrode disposed on the mounting surface, like in the conventional coil component, since the coil is disposed in a region in which the cracks can occur, disconnection may occur in the coil when the cracks are generated in the element body. Accordingly, in the conventional coil component, reliability may decrease.

One aspect of the present invention is to provide a coil component capable of improving reliability.

A coil component according to one aspect of the present invention includes an element body which includes a pair of end surfaces facing each other, a pair of main surfaces facing each other, and a pair of side surfaces facing each other and in which one of the main surfaces is a mounting surface, a coil disposed in the element body, and a first external electrode and a second external electrode disposed on a side of each of the pair of end surfaces of the element body, wherein each of the first external electrode and the second external electrode includes a first portion disposed on the end surface, a second portion disposed on one main surface, and a third portion disposed on the other main surface, a coil axis of the coil extends in a facing direction of the pair of side surfaces, one end of the coil and the first external electrode are electrically connected by a first connecting portion, and the other end of the coil and the second external electrode are electrically connected by a second connecting portion, each of the first connecting portion and the second connecting portion is disposed closer to a side of the other main surface facing the mounting surface than a center of the pair of main surfaces in a facing direction, at least a part of the coil is disposed in a first region partitioned by a first straight line which connects a first contact point between an edge of the second portion of the first external electrode and one main surface to a second contact point between an edge of the third portion and the other main surface, a center line which passes through the center and extends in a facing direction of the pair of end surfaces, one end surface, and the other main surface, and a second region partitioned by a second straight line which connects a third contact point between an edge of the second portion of the second external electrode and one main surface to a fourth contact point between an edge of the third portion and the other main surface, the center line, the other end surface, and the other main surface when seen in the facing direction of the pair of side surfaces, and the coil is not disposed in a third region partitioned by a third straight line which connects the first contact point to a first intersection point between the center line and one end surface, the one end surface, and one main surface, and a fourth region partitioned by a fourth straight line which connects the third contact point to a second intersection point between the center line and the other end surface, the other end surface, and the one main surface when seen in the facing direction of the pair of side surfaces.

In the coil component according to one aspect of the present invention, the coil is not disposed in the third region and the fourth region. The third region and the fourth region are regions in which cracks may occur when cracks are generated in the element body starting from edges of the second portion of the first external electrode and the second external electrode. In the coil component, since the first connecting portion and the second connecting portion are disposed closer to the side of the other main surface facing the mounting surface than the center of the pair of main surfaces in the facing direction, and the coil is not disposed in the third region and the fourth region, it is possible to avoid disconnection of the first connecting portion, the second connecting portion and the coil even when cracks are generated starting from the edges of the second portion of the first external electrode and the second external electrode. Therefore, in the coil component, even when cracks occur in the element body, characteristics are not affected. As a result, in the coil component, reliability can be improved. Also, in the coil component, at least a part of the coil is disposed in the first region and the second region. In this way, in the coil component, a diameter (a length) of the coil can be secured by disposing the coil in a region in which no cracks occur. Therefore, in the coil component, the coil characteristics (Q values) can be improved.

In one embodiment, at least a part of an inner edge of the coil may be disposed in each of the first region and the second region when seen in the facing direction of the pair of side surfaces. In this configuration, since the inner edge of the coil is located in each of the first region and the second region, the diameter of the coil can be further secured. Therefore, in the coil component, the coil characteristics can be improved.

In one embodiment, each of the first external electrode and the second external electrode may have a fourth portion disposed on one side surface, and a fifth portion disposed on the other side surface. With this configuration, it is possible to increase rigidity of the first external electrode and the second external electrode.

In one embodiment, at least a part of the coil may be disposed between the center line and one main surface when seen in the facing direction of the pair of side surfaces. With this configuration, the diameter of the coil can be secured in a configuration in which the coil is not disposed in the third region and the fourth region.

In one embodiment, the coil may not be disposed in a fifth region partitioned by the first straight line, the center line and the third straight line and a sixth region partitioned by the second straight line, the center line and the fourth straight line when seen in the facing direction of the pair of side surfaces. In this configuration, the coil is not disposed in the fifth region and the sixth region in the vicinity of the third region and the fourth region. Therefore, in the coil component, occurrence of the disconnection in the coil can be reliably avoided.

According to one aspect of the present invention, it is possible to improve reliability of the coil component.

### BRIEF DESCRIPTION OF THE DRAWINGS

FIG. 1 is a perspective view of a laminated coil component according to one embodiment.

FIG. 2 is an exploded perspective view of an element body in the laminated coil component shown in FIG. 1.

FIG. 3 is a diagram showing a cross-sectional configuration of the laminated coil component.

FIG. 4 is a diagram showing a cross-sectional configuration of a laminated coil component according to another embodiment.

FIG. 5 is a diagram showing a cross-sectional configuration of a laminated coil component according to another embodiment.

FIG. 6 is a diagram showing a cross-sectional configuration of a laminated coil component according to another embodiment.

FIG. 7 is a diagram showing a cross-sectional configuration of a laminated coil component according to another embodiment.

FIG. 8 is a diagram showing a cross-sectional configuration of a laminated coil component according to another embodiment.

### DETAILED DESCRIPTION

Hereinafter, preferred embodiments of the present invention will be described in detail with reference to the accompanying drawings. In the description of the drawings, the same or corresponding elements are designated by the same reference numerals, and redundant explanations will be omitted.

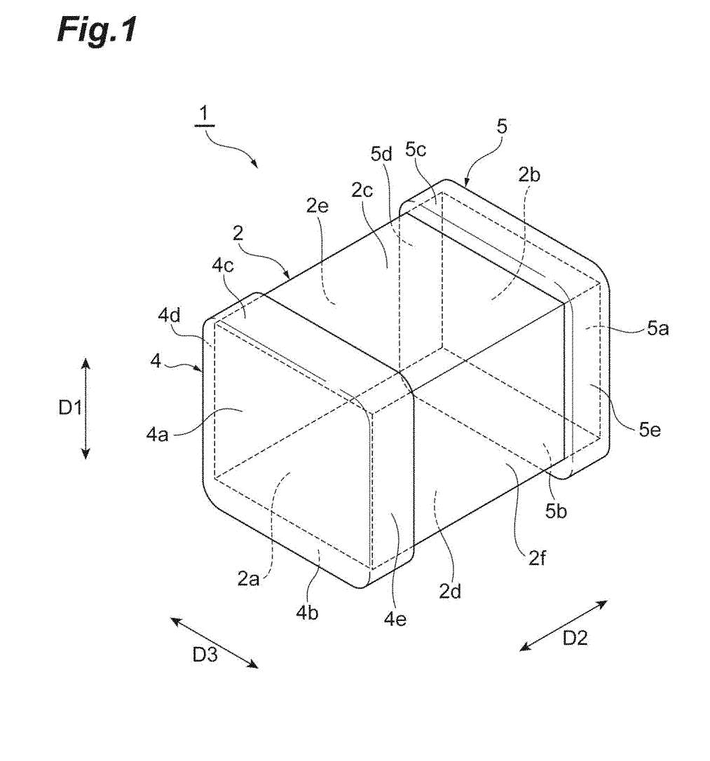

As shown in FIG. 1, a laminated coil component 1 includes an element body 2, and a first external electrode 4 and a second external electrode 5 disposed at both ends of the element body 2.

The element body 2 has a rectangular parallelepiped shape. The rectangular parallelepiped shape includes a rectangular parallelepiped shape in which corner portions and ridge portions are chamfered, and a rectangular parallelepiped shape in which the corner portions and the ridge portions are rounded. The element body 2 has a pair of end surfaces 2a and 2b facing each other, a pair of main surfaces 2c and 2d facing each other, and a pair of side surfaces 2e and 2f facing each other as outer surfaces. The facing direction in which the pair of main surfaces 2c and 2d face each other is a first direction D1. The facing direction in which the pair of end surfaces 2a and 2b face each other is a second direction D2. The facing direction in which the pair of side faces 2e and 2f face each other is a third direction D3. In the embodiment, the first direction D1 is a height direction of the element body 2. The second direction D2 is a longitudinal direction of the element body 2 and is orthogonal to the first direction D1. The third direction D3 is a width direction of the element body 2 and is orthogonal to the first direction D1 and the second direction D2.

The pair of end surfaces 2a and 2b extend in the first direction D1 to connect a space between the pair of main surfaces 2c and 2d. The pair of end surfaces 2a and 2b also extend in the third direction D3 (a short side direction of the pair of main surfaces 2c and 2d). The pair of side surfaces 2e and 2f extend in the first direction D1 to connect a space between the pair of main surfaces 2c and 2d. The pair of side surfaces 2e and 2f also extend in the second direction D2 (a long side direction of the pair of end surfaces 2a and 2b). In the embodiment, the main surface 2d is defined as a mounting surface facing another electronic device when the laminated coil component 1 is mounted on another electronic device (for example, a circuit board, an electronic component, or the like).

The element body 2 is configured by stacking a plurality of dielectric layers (insulator layers) 11 in a direction in which the pair of side surfaces 2e and 2f face each other. In the element body 2, the stacking direction of the plurality of dielectric layers 11 (hereinafter, simply referred to as “stacking direction”) coincides with the third direction D3. Each of the dielectric layers 11 is composed of a sintered body of a ceramic green sheet including, for example, a dielectric material (a BaTiO₃-based, Ba(Ti, Zr)O₃-based, or (Ba, Ca)TiO₃-based dielectric ceramic or the like). In the actual element body 2, the dielectric layers 11 are integrated to such an extent that boundaries between the dielectric layers 11 are not visible.

The first external electrode 4 is disposed on the side of the end surface 2a of the element body 2, and the second external electrode 5 is disposed on the side of the end surface 2b of the element body 2. That is, the first external electrode 4 and the second external electrode 5 are located apart from each other in the facing direction of the pair of end surfaces 2a and 2b. The first external electrode 4 and the second external electrode 5 contain a conductive material (for example, Ag, Pd or the like). The first external electrode 4 and the second external electrode 5 are composed of a sintered body of a conductive paste containing a conductive metal powder (for example, Ag powder, Pd powder or the like) and a glass frit. Electroplating is applied to the first external electrode 4 and the second external electrode 5 so that a plating layer is formed on surfaces thereof. For example, Ni, Sn or the like is used for the electroplating.

The first external electrode 4 is disposed on the side of one end surface 2a. The first external electrode 4 includes five electrode portions including a first electrode portion (a first portion) 4a located on the end surface 2a, a second electrode portion (a second portion) 4b located on the main surface 2d, a third electrode portion (a third portion) 4c located on the main surface 2c, a fourth electrode portion (a fourth portion) 4d located on the side surface 2e, and a fifth electrode portion (a fifth portion) 4e located on the side surface 2f. The first electrode portion 4a, the second electrode portion 4b, the third electrode portion 4c, the fourth electrode portion 4d, and the fifth electrode portion 4e are connected at ridge portions of the element body 2 and are electrically connected to each other. The first external electrode 4 is formed on five surfaces including one end surface 2a, the pair of main surfaces 2c and 2d, and the pair of side surfaces 2e and 2f. The electrode portions 4a, 4b, 4c, 4d and 4e are integrally formed.

The second external electrode 5 is disposed on the side of the other end surface 2b. The second external electrode 5 includes five electrode portions including a first electrode portion (a first portion) 5a located on the end surface 2b, a second electrode portion (a second portion) 5b located on the main surface 2d, a third electrode portion (a third portion) 5c located on the main surface 2c, a fourth electrode portion (a fourth portion) 5d located on the side surface 2e, and a fifth electrode portion (a fifth portion) 5e located on the side surface 2f. The first electrode portion 5a, the second electrode portion 5b, the third electrode portion 5c, the fourth electrode portion 5d, and the fifth electrode portion 5e are connected at ridge portions of the element body 2 and are electrically connected to each other. The second external electrode 5 is formed on five surfaces including one end surface 2b, the pair of main surfaces 2c and 2d, and the pair of side surfaces 2e and 2f. The electrode portions 5a, 5b, 5c, 5d and 5e are integrally formed.

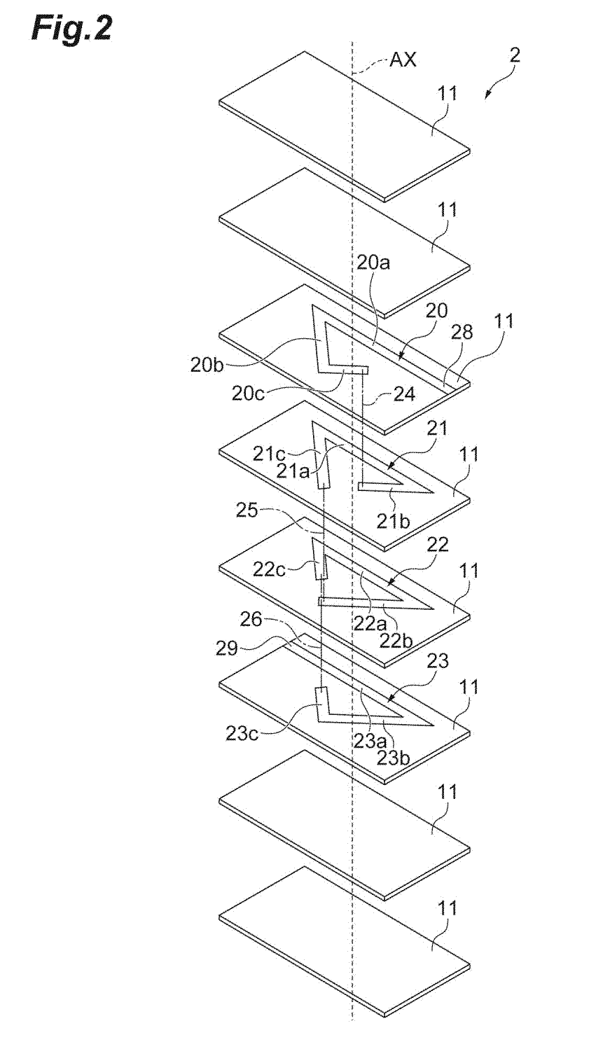

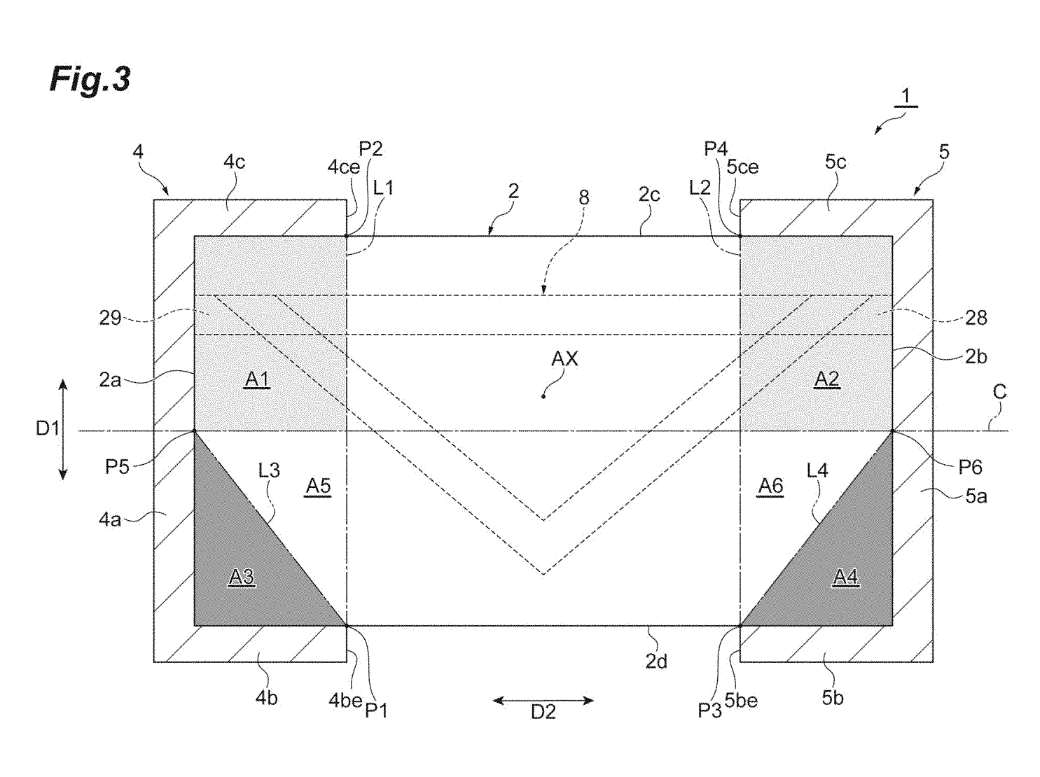

In the laminated coil component 1, as shown in FIG. 3, a coil 8 is disposed in the element body 2. As shown in FIG. 2, the coil 8 is formed by electrically connecting a first conductor 20, a second conductor 21, a third conductor 22, and a fourth conductor 23. Each of the conductors 20 to 23 is formed of a conductive material usually used as a conductor for a coil (for example, Ni, Cu or the like). Each of the conductors 20 to 23 is composed of a sintered body of a conductive paste containing the above-described conductive material.

The first conductor 20 has a first portion 20a, a second portion 20b, and a third portion 20c. Each of the portions 20a to 20c has a predetermined width and has a linear shape. The first portion 20a constitutes one end of the coil 8. The first portion 20a and the second external electrode 5 are electrically connected by a second connecting portion 28. The second connecting portion 28 is formed integrally with the first portion 20a. The second connecting portion 28 is exposed on the end surface 2b of the element body 2 and is directly connected to the second external electrode 5.

The second conductor 21 has a first portion 21a, a second portion 21b and a third portion 21c. Each of the portions 21a to 21c has a predetermined width and has a linear shape. The first conductor 20 and the second conductor 21 are electrically connected by a through-hole conductor 24. Specifically, one end of the third portion 20c of the first conductor 20 and one end of the second portion 21b of the second conductor 21 are connected by the through-hole conductor 24.

The third conductor 22 has a first portion 22a, a second portion 22b and a third portion 22c. Each of the portions 22a to 22c has a predetermined width and has a linear shape. The second conductor 21 and the third conductor 22 are electrically connected by a through-hole conductor 25. Specifically, one end of the third portion 21c of the second conductor 21 and one end of the second portion 22b of the third conductor 22 are connected by the through-hole conductor 25.

The fourth conductor 23 has a first portion 23a, a second portion 23b and a third portion 23c. Each of the portions 23a to 23c has a predetermined width and has a linear shape. The first portion 23a constitutes the other end of the coil 8. The first portion 23a and the first external electrode 4 are electrically connected by a first connecting portion 29. The first connecting portion 29 is formed integrally with the first portion 23a. The first connecting portion 29 is exposed on the end surface 2a of the element body 2 and is directly connected to the first external electrode 4. The third conductor 22 and the fourth conductor 23 are electrically connected by a through-hole conductor 26. Specifically, one end of the third portion 22c of the third conductor 22 and one end of the third portion 23c of the fourth conductor 23 are connected by the through-hole conductor 26.

As shown in FIG. 3, a coil axis AX (a direction of an axial center) of the coil 8 extends in the third direction D3 (the facing direction of the pair of side surfaces 2e and 2f). The coil axis AX of the coil 8 extends to be parallel to the main surface 2d which is the mounting surface of the element body 2. In the embodiment, the coil 8 has a substantially triangular shape when viewed in the third direction D3 (when seen in a direction along the coil axis AX).

In the laminated coil component 1, each of the second connecting portion 28 and the first connecting portion 29 is disposed closer to the side of the main surface 2c (the side opposite to the main surface 2d which is the mounting surface) than a center (a position of ½) of the element body 2 in the first direction D1 (the height direction of the laminated coil component 1). The second connecting portion 28 is disposed in a second region A2 which will be described later when seen in the third direction D3. The first connecting portion 29 is disposed in a first region A1 which will be described later when seen in the third direction D3.

A region of the element body 2 partitioned by a center line C passing through a center of the first direction D1 and extending in the second direction D2, a first straight line L1 which connects a first contact point P1 between an edge (an end surface) 4be of the second electrode portion 4b of the first external electrode 4 and the main surface 2d to a second contact point P2 between an edge 4ce of the third electrode portion 4c and the main surface 2c, the end surface 2a and the main surface 2c is defined as a first region A1 when seen in the third direction D3. That is, the first region A1 is a region surrounded by the center line C, the first straight line L1, and the end surface 2a, and the main surface 2c of the element body 2. The first region A1 has a rectangular shape.

A region of the element body 2 partitioned by the center line C, a second straight line L2 which connects a third contact point P3 between an edge 5be of the second electrode portion 5b of the second external electrode 5 and the main surface 2d to a fourth contact point P4 between an edge 5ce of the third electrode portion 5c and the main surface 2c, the end surface 2b and the main surface 2c is defined as a second region A2 when seen in the third direction D3. That is, the second region A2 is a region surrounded by the center line C, the second straight line L2, and the end surface 2b and the main surface 2c of the element body 2. The second region A2 has a rectangular shape.

A region of the element body 2 partitioned by a third straight line L3 which connects a first intersection point P5 between the center line C and the end surface 2a to the first contact point P1 between the edge 4be of the second electrode portion 4b of the first external electrode 4 and the main surface 2d, and the end surface 2a and the main surface 2d is defined as a third region A3 when seen in the third direction D3. That is, the third region A3 is a region surrounded by the third straight line L3, and the end surface 2a and the main surface 2d of the element body 2. The third region A3 has a triangular shape.

A region of the element body 2 partitioned by a fourth straight line L4 which connects a second intersection point P6 between the center line C and the end surface 2a to the fourth contact point P4 between the edge 5be of the second electrode portion 5b of the second external electrode 5 and the main surface 2d, and the end surface 2b and the main surface 2d is defined as a fourth region A4 when seen in the third direction D3. That is, the fourth region A4 is a region surrounded by the fourth straight line L4, and the end surface 2b and the main surface 2d of the element body 2. The fourth region A4 has a triangular shape.

A region of the element body 2 partitioned by the first straight line L1, the center line C and the third straight line L3 is defined as a fifth region A5 when seen in the third direction D3. That is, the fifth region A5 is a region surrounded by the first region A1, the third region A3 and the first straight line L1. The fifth region A5 has a triangular shape.

A region of the element body 2 partitioned by the second straight line L2, the center line C and the fourth straight line L4 is defined as a sixth region A6 when seen in the third direction D3. That is, the sixth region A6 is a region surrounded by the second region A2, the fourth region A4 and the second straight line L2. The sixth region A6 has a triangular shape.

When seen in the third direction D3, a part of the coil 8 is disposed in each of the first region A1 and the second region A2. Specifically, parts of an outer edge and an inner edge of a portion of the coil 8 located closer to the side of the main surface 2c than the center line C are disposed in each of the first region A1 and the second region A2. In the embodiment, when seen in the third direction D3, a part of the coil 8 is disposed in a region closer to the side of the main surface 2d than the center line C3. Specifically, a part including the outer edge and the inner edge of the coil 8 is disposed in the region closer to the side of the main surface 2d than the center line C.

When seen in the third direction D3, the coil 8 is not disposed at a position overlapping with the third region A3 and the fourth region A4. That is, when seen in the third direction D3, a conductor constituting the coil 8 is not disposed at the position overlapping with the third region A3 and the fourth region A4. Further, when seen in the third direction D3, the coil 8 is not disposed at a position overlapping with the fifth region A5 and the sixth region A6. That is, when seen in the third direction D3, the conductor constituting the coil 8 is not disposed at the position overlapping with the fifth region A5 and the sixth region A6.

As described above, in the laminated coil component 1 according to the embodiment, the coil is not disposed in the third region A3 and the fourth region A4. The third region A3 and the fourth region A4 are regions in which cracks can occur when cracks are generated in the element body 2 starting from the edge 4be of the second electrode portion 4b of the first external electrode 4 and/or the edge 5be of the second electrode portion 5b of the second external electrode 5. In the laminated coil component 1, since the first connecting portion 29 and the second connecting portion 28 are disposed closer to the side of the other main surface 2c facing the mounting surface than a center of the pair of main surfaces 2c and 2d in the facing direction (the first direction D1), and the coil 8 is not disposed in the third region A3 and the fourth region A4, even when cracks are generated starting from the edges of the second electrode portions 4b and 5b of the first external electrode 4 and the second external electrode 5, it is possible to avoid disconnection of the first connecting portion 29, the second connecting portion 28 and the coil 8. Therefore, in the laminated coil component 1, even when cracks occur in the element body 2, characteristics thereof are not affected. As a result, in the laminated coil component 1, reliability can be improved. Also, in the laminated coil component 1, at least a part of the coil 8 is disposed in the first region A1 and the second region A2. In this way, in the laminated coil component 1, a diameter (a length) of the coil 8 can be secured by disposing the coil 8 in a region in which no crack occurs. Therefore, in the laminated coil component 1, the coil characteristics (Q values) can be improved.

In the laminated coil component 1 according to the embodiment, at least a part of the inner edge of the coil 8 is disposed in the first region A1 and the second region A2 when seen in the third direction D3. In this configuration, since the inner edge of the coil 8 is located in the first region A1 and the second region A2, the diameter of the coil 8 can be further secured. Therefore, in the laminated coil component 1, the coil characteristics can be improved.

In the laminated coil component 1 according to the embodiment, the first external electrode 4 is formed on five surfaces including one end surface 2a, the pair of main surfaces 2c and 2d, and the pair of side surfaces 2e and 2f. The second external electrode 5 is formed on five surfaces including one end surface 2b, the pair of main surfaces 2c and 2d, and the pair of side surfaces 2e and 2f. With this configuration, it is possible to increase rigidity of the first external electrode 4 and the second external electrode 5.

In the laminated coil component 1 according to the embodiment, at least a part of the outer edge of the coil 8 is disposed between the center line C and one main surface 2d when seen in the third direction D3. With this configuration, the diameter of the coil 8 can be ensured in a configuration in which the coil 8 is not disposed in the third region A3 and the fourth region A4.

In the laminated coil component 1 according to the embodiment, the coil 8 is not disposed in the fifth region A5 partitioned by the first straight line L1, the center line C and the third straight line L3 and the sixth region A6 partitioned by the second straight line L2, the center line C and the fourth straight line L4 when seen in the third direction D3. In this configuration, the coil 8 is not disposed in the fifth region A5 and the sixth region A6 in the vicinity of the third region A3 and the fourth region A4. Therefore, in the laminated coil component 1, occurrence of the disconnection in the coil 8 can be reliably avoided.

Although the embodiments of the present invention have been described above, the present invention is not necessarily limited to the above-described embodiments, and various modifications are possible without departing from the gist thereof.

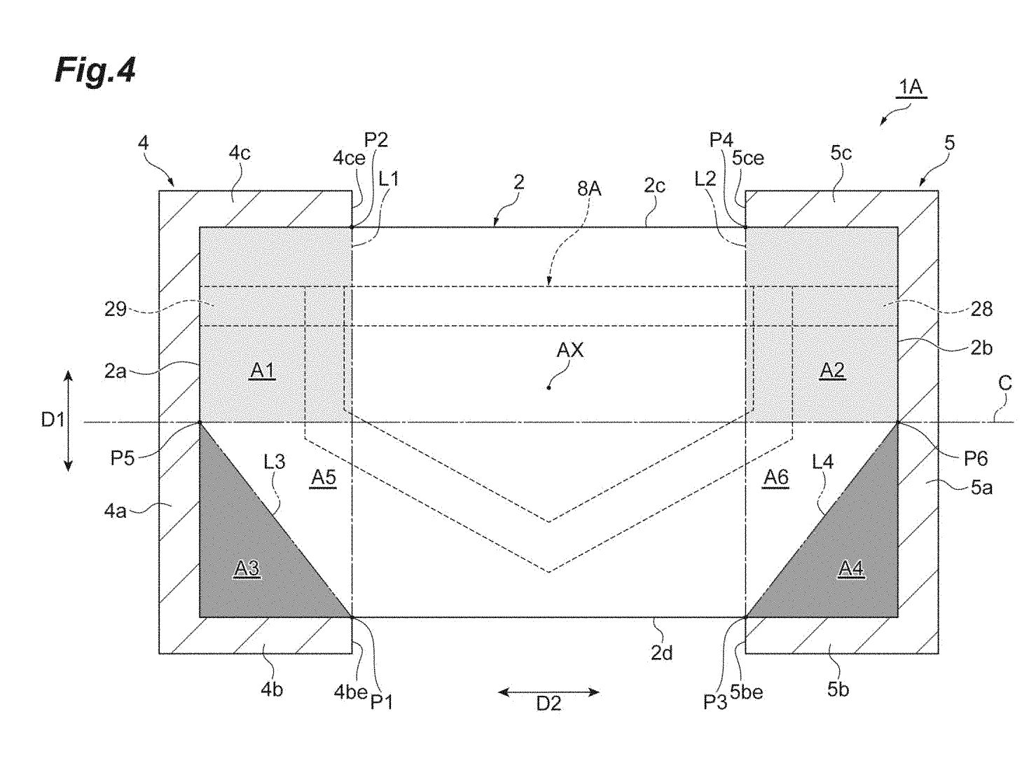

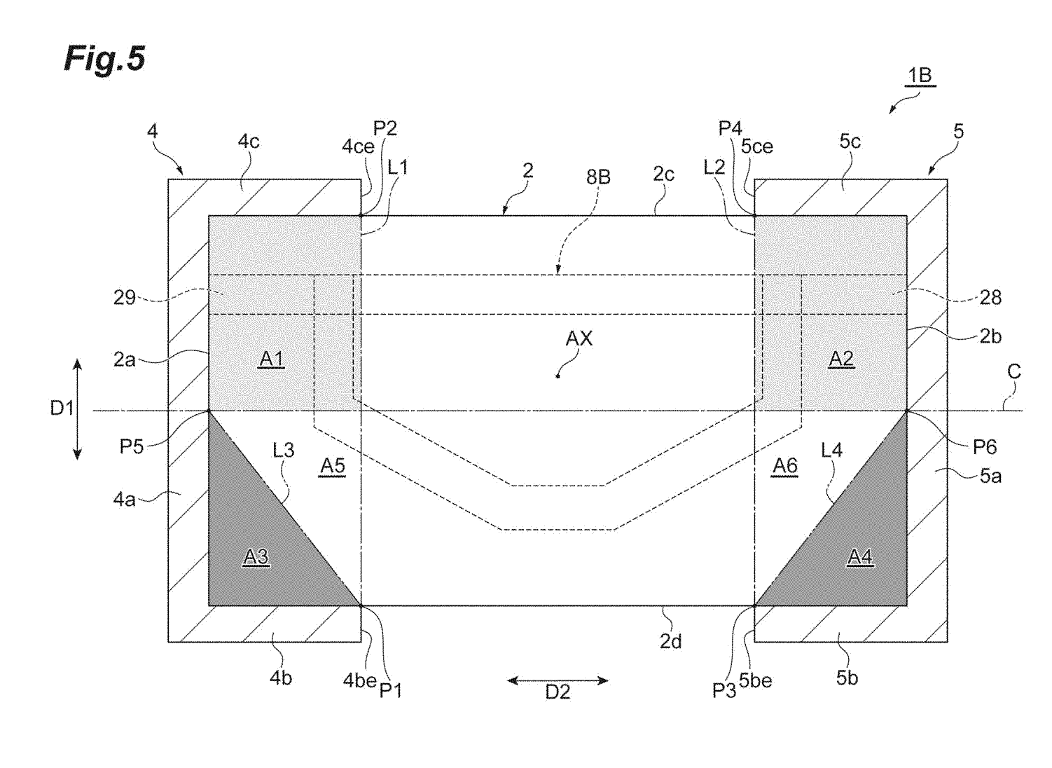

In the above-described embodiment, as an example, the coil 8 has a triangular shape when seen in the third direction D3. However, the shape of the coil is not limited to the triangular shape. As shown in FIG. 4, in a laminated coil component 1A, portions of a coil 8A located in the first region A1 and the second region A2 have a linear shape in the first direction D1. As shown in FIG. 5, in the laminated coil component 1B, portions of a coil 8B located in the first region A1 and the second region A2 have a linear shape in the first direction D1, and a top portion located closer to the side of the main surface 2d than the center line C has a linear shape in the second direction D2.

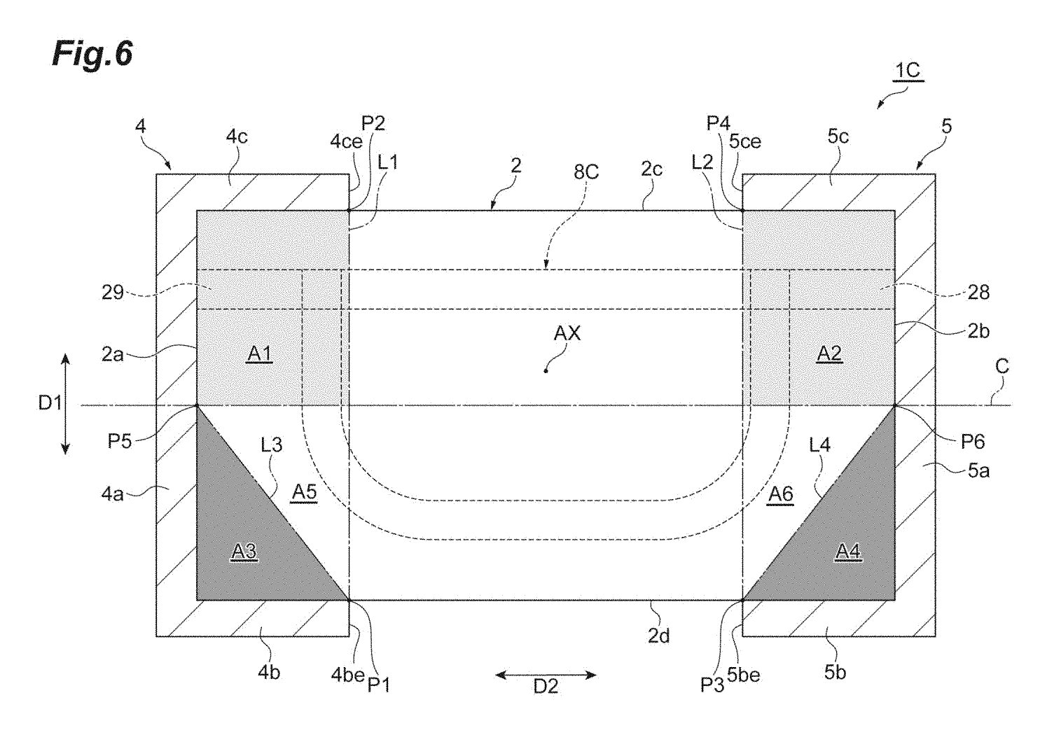

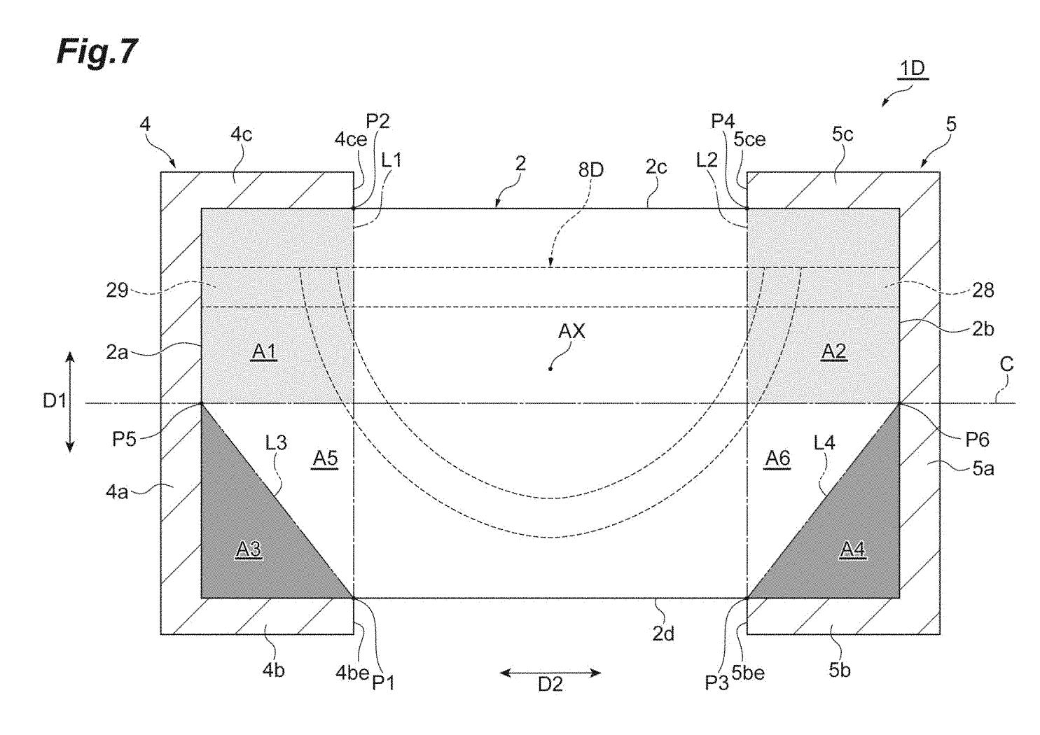

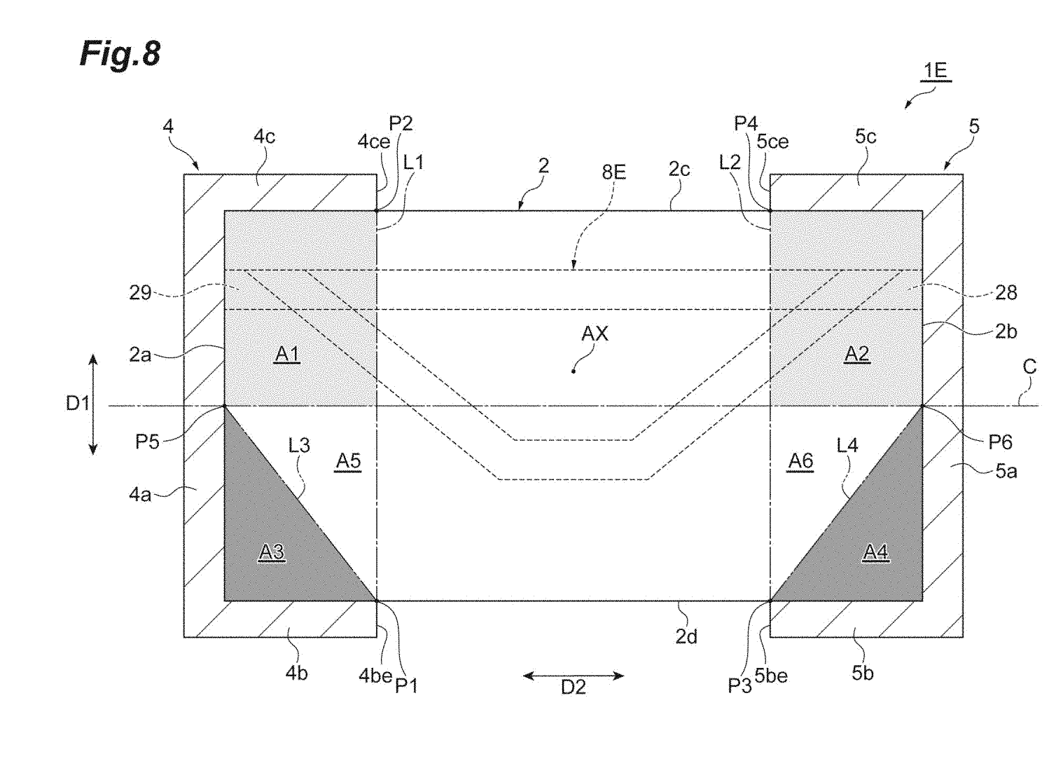

As shown in FIG. 6, in a laminated coil component 1C, a coil 8C has a semicylindrical shape. As shown in FIG. 7, in a laminated coil component 1D, a coil 8D has a semicircular shape. As shown in FIG. 8, in a laminated coil component 1E, a coil 8E has a trapezoidal shape.

In the above-described embodiment, the coil 8 is composed of four conductors including the first conductor 20, the second conductor 21, the third conductor 22, and the fourth conductor 23 as an example. However, the number of conductors constituting the coil 8 is not limited to four and may be set as appropriate.

In the above-described embodiment, a type in which the first external electrode 4 has the five electrode portions 4a, 4b, 4c, 4d and 4e and the second external electrode 5 has the five electrode portions 5a, 5b, 5c, 5d and 5e has been described as an example. However, the first external electrode 4 may have at least the electrode portions 4a, 4b and 4c, and the second external electrode 5 may have at least the electrode portions 5a, 5b and 5c.

In the above-described embodiment, a type in which a part of each of the coils 8, 8A to 8E is disposed closer to the side of the main surface 2d than the center line C when seen in the third direction D3 has described as an example. However, when seen in the third direction D3, the coil may not be disposed closer to side of the main surface 2d than the center line C. That is, the coil may be disposed closer to only the side of the main surface 2c than the center line when seen in the third direction D3.

What is claimed is:

1. A coil component comprising:
an element body which includes a pair of end surfaces facing each other, a pair of main surfaces facing each other, and a pair of side surfaces facing each other and in which one of the main surfaces is a mounting surface,
a coil disposed in the element body, and
a first external electrode and a second external electrode disposed on a side of each of the pair of end surfaces of the element body,
wherein each of the first external electrode and the second external electrode includes a first portion disposed on the end surface, a second portion disposed on one main surface, and a third portion disposed on the other main surface,
a coil axis of the coil extends in a facing direction of the pair of side surfaces,
one end of the coil and the first external electrode are electrically connected by a first connecting portion, and the other end of the coil and the second external electrode are electrically connected by a second connecting portion,
each of the first connecting portion and the second connecting portion is disposed closer to a side of the other main surface facing the mounting surface than a center of the pair of main surfaces in a facing direction,
at least a part of the coil is disposed in a first region partitioned by a first straight line which connects a first contact point between an edge of the second portion of the first external electrode and one main surface to a second contact point between an edge of the third portion and the other main surface, a center line which passes through the center and extends in a facing direction of the pair of end surfaces, one end surface, and the other main surface, and a second region partitioned by a second straight line which connects a third contact point between an edge of the second portion of the second external electrode and one main surface to a fourth contact point between an edge of the third portion and the other main surface, the center line, the other end surface, and the other main surface when seen in the facing direction of the pair of side surfaces, and
the coil is not disposed in a third region partitioned by a third straight line which connects the first contact point to a first intersection point between the center line and one end surface, the one end surface, and one main surface, and a fourth region partitioned by a fourth straight line which connects the third contact point to a second intersection point between the center line and the other end surface, the other end surface, and the one main surface when seen in the facing direction of the pair of side surfaces.

2. The coil component according to claim 1, wherein at least a part of an inner edge of the coil is disposed in each of the first region and the second region when seen in the facing direction of the pair of side surfaces.

3. The coil component according to claim 1, wherein each of the first external electrode and the second external electrode has a fourth portion disposed on one side surface and a fifth portion disposed on the other side surface.

4. The coil component according to claim 1, wherein at least a part of the coil is disposed between the center line and one main surface when seen in the facing direction of the pair of side surfaces.

5. The coil component according to claim 1, wherein the coil is not disposed in a fifth region partitioned by the first straight line, the center line, and the third straight line and a sixth region partitioned by the second straight line, the center line, and the fourth straight line when seen in the facing direction of the pair of side surfaces.
